(19) United States
(12) Patent Application Publication
(10) Pub. No.: US 2018/0154268 A1
(43) Pub. Date: Jun. 7, 2018

(54) iSPY Target Mode

(71) Applicant: Marc Alan Mulcahy, Lakeside, MT (US)

(72) Inventor: Marc Alan Mulcahy, Lakeside, MT (US)

(21) Appl. No.: 15/371,534

(22) Filed: Dec. 7, 2016

(51) Int. Cl. A63F 13/837; H04W 4/02; A63F 13/216; A63F 13/355; A63F 13/92; G01S 19/14

(52) U.S. Cl. CPC A63F 13/837; H04W 4/023; G01S 19/14; A63F 13/355; A63F 13/92; A63F 13/216

(57) ABSTRACT

Until now, GPS software has been used to show locations of people, places, or things. In location based mobile games, GPS is used to show local spots. ISPY's Target Mode uses GPS software in a new way. The most notable GPS function of iSPY, and the reason for my patent application, is what iSPY does during live engagements involving multiple players. Each of the many different weapons used in iSPY has a real-world range that is governed by GPS software. When players shoot each other, iSPY measures the distance between the 2 players/phones and uses this information to determine if the shot was taken with a weapon using the appropriate range, thus determining a hit or miss (i.e. if the target is 60′ away, the shooter must use a weapon with at least a 60′ range to score a hit).

“Target Mode” is intended for mobile cell phone applications and tablets. Target Mode uses GPS software and mapping technologies to measure and govern ranges or distances between multiple, live, and/or moving cell phones or tablets, then uses this data in conjunction with various distance-related aspects of cell phone applications.

For instance, with regards to the ISPY cell phone game, Target Mode automatically alerts players whenever another logged in player's cell phone comes within one mile of their location. Target Mode automatically tracks all players' cell phones within the one-mile distance, with each player's location marked by a floating map pin. Tapping a marker pin, targets that specific player and also tells Target Mode to use the live tracking distance between the target and the player as part of the criteria when calculating a hit or miss shot taken at this specific target.

Tapping the Target Mode button at any time, triggers the user's camera screen to initiate. When players use their phone's camera to take a (picture) shot at another player, Target Mode uses the distance measurement between the 2 cell phones to determine if the shot is a hit or a miss. Target Mode determines a hit or miss depending on whether or not the game's weapon being used by the player's cell phone at the time of the shot is within the specified distance range for that weapon. For instance, a pistol may have a maximum range of 15 meters between the 2 cell phones in the real world, so any shot taken outside this range is automatically determined to be a miss by Target Mode. Target Mode then sends a warning to the (out-of-Range) target telling them that a player has taken a shot at them. A shot within the specified range may or may not be determined a hit.

This second part of a “hit” determination comes from whether or not any part of the target's head or body is touching the red, target dot which is seen on each Target Mode scope view. Each weapon has a different sized red dot visible on the camera screen. For instance, when the pistol is being used, you will the red dot is larger, due to the closeness of proximity and smaller range of the weapon.

To sum up Target Mode's functions; A player is alerted about an enemy player once the enemy player is within one mile of their location. The enemy player is tracked, live until they fall out of this one-mile proximity. Tapping the Target Mode button, initiates the camera screen on the phone and provides a red target button. Once a player has a visual of another player and can take a photo of the other player, they choose a range-appropriate weapon, tap the Target Mode button, then take the shot (photo) of the target with the intention of making sure the red dot is somewhere on the target's head or body.

Once Target Mode has determined that a shot was either out of range or within the range of the selected weapon at the time of the shot, Target Mode then sends the appropriate, aforementioned information to the target via cell phones. If the information sent is a photo of the shot taken, the target looks at the photo to see if the shot includes the red dot hitting or covering any part of their head or body. If this is the case, then the target taps the confirm button to confirm the shot was a hit.

1. “Target Mode” uses GPS technology to determine whether or not the distance between 2 (two) cell phones comes within predetermined ranges for varied and specific weapons in mobile gaming apps.
